(19) United States
(12) Patent Application Publication
(10) Pub. No.: US 2014/0304063 A1
(43) Pub. Date: Oct. 9, 2014

(54) DETERMINING RESOURCE ALLOCATION FOR CONTENT DISTRUBUTION

(71) Applicant: Google Inc., Mountain View, CA (US)

(72) Inventors: Michael F. English, Seattle, WA (US); Ekaterina A. Mineeva, Kenmore, WA (US); Will Stoltzman, Seattle, WA (US); Lee Callender, Seattle, WA (US); Douglas R. Bengtson, Seattle, WA (US)

(73) Assignee: Google Inc., Mountain View, CA (US)

(21) Appl. No.: 13/856,512

(22) Filed: Apr. 4, 2013

(51) Int. Cl. G06Q 30/02

(52) U.S. Cl. CPC G06Q 30/0243
USPC 705/14.42

(57) ABSTRACT

An example system includes: identifying campaigns for content distribution for which conversion information has been collected over time and stored in a database in computer storage, where the identified campaigns have at least one subject in common; for each of at least some of the campaigns, performing operations that include: identifying distribution clusters associated with the campaign, and determining relative conversion rates for the distribution clusters; and using relative conversion rates for distribution clusters, which have one or more features in common and are in different campaigns, in determining how to allocate resources for the content distribution.

### TECHNICAL FIELD

This disclosure relates generally to determining resource allocation for content distribution.

### BACKGROUND

The Internet provides access to a wide variety of resources. For example, video, audio, and Web pages are accessible over the Internet. These resources present opportunities for other content (e.g., advertisements, or “ads”) to be provided along with the resources. For example, a Web page can include slots in which ads can be presented. The slots can be allocated to content providers (e.g., advertisers). An auction can be performed for the right to present advertising in a slot. In the auction, content providers provide bids specifying amounts that the content providers are willing to pay for presentation of their content.

Content providers, such as advertisers, may distribute content through an auction, or outside of the context of an auction, based on various types of information. Examples of such information include, but are not limited to, keywords, geography, and demographics. Content providers, however, have limited resources (e.g., money). Content providers attempt to allocate those resources to methods of content distribution that provide an overall benefit, such as an increased number of conversions.

### SUMMARY

An example process for determining resource allocation for content distribution may include identifying campaigns for content distribution for which conversion information has been collected over time and stored in a database in computer storage, where the identified campaigns have at least one subject in common. For each of at least some of the campaigns, the following operations may be performed: identifying distribution clusters associated with the campaign, where a distribution cluster includes a type of information used to distribute content and one or more instances of the type of information; and determining relative conversion rates for the distribution clusters, where a relative conversion rate indicates a performance of a distribution cluster relative to a baseline performance for the campaign, and where at least some of the distribution clusters use different types of information to distribute content. The example process may use relative conversion rates for distribution clusters, which have one or more features in common and are in different campaigns, in determining how to allocate resources for the content distribution. The example process may include one or more of the following features, either alone or in combination.

Determining the relative conversion rates may include: establishing a set of equations, where each equation relates a conversion rate for a campaign, a conversion rate for a distribution cluster in multiple campaigns, and an observed conversion rate for the distribution cluster in the campaign; and solving the set of equations to determine a relative conversion rate for the distribution cluster. The set of equation may be solved using iterative proportional fitting.

Determining how to allocate the resources may include relating the relative conversion rates to resources to achieve the relative conversion rates. Relating the relative conversion rates to resources may include generating a graph of the relative conversion rates to the resources.

The content may include advertising and each relative conversion rate may relate a conversion for corresponding advertising to a baseline performance for the advertising using the type of information and the one or more instances of the type of information. The type of information used to distribute content may include a category of information and the instances may include elements of the category. The category may be keywords and the elements may include individual keywords that are related. The example processes may identify keywords among keywords used to distribute content; and use a hierarchical structure to relate at least some of the identified keywords.

Two or more of the features described in this disclosure/specification, including this summary section, can be combined to form implementations not specifically described herein.

The systems and techniques described herein, or portions thereof, can be implemented as a computer program product that includes instructions that are stored on one or more non-transitory machine-readable storage media, and that are executable on one or more processing devices. The systems and techniques described herein, or portions thereof, can be implemented as an apparatus, method, or electronic system that can include one or more processing devices and memory to store executable instructions to implement the stated operations.

The details of one or more implementations are set forth in the accompanying drawings and the description below. Other features and advantages will be apparent from the description and drawings, and from the claims.

### DESCRIPTION OF THE DRAWINGS

FIG. 1 is a block diagram of an example network environment on which the example processes described herein can be implemented.

FIG. 2 is an example a process for determining resource allocation for content distribution.

FIG. 3 is an example of a graph showing relative conversion rate plotted against resources allocated.

FIG. 4 is an example of a computer system on which the processes described herein may be implemented.

Like reference symbols in the various drawings indicate like elements.

### DETAILED DESCRIPTION

Content, such as advertising, may be provided to network users based, e.g., on demographics, keywords, language, and interests. For example, advertising (an “ad”) may be associated with one or more keywords that are stored as metadata along with the ad. A search engine, which operates on the network, may receive input from a user. The input may include one or more of the keywords. A content management system, which serves ads, may receive the keywords from the search engine, identify the ad as being associated with one or more of the keywords, and output the ad to the user, along with content that satisfies the initial search request. The content and the ad are displayed on a computing device. When displayed, the ad is incorporated into an appropriate slot on the results page. The user may select the ad by clicking-on the ad. In response, a hyperlink associated with the ad directs the user to another Web page. For example, if the ad is for ABC Travel Company, the Web page to which the user is directed may be the home page for ABC Travel Company. This activity is known as click-through. In this context, a “click” is not limited to a mouse click, but rather may include a touch, a programmatic selection, or any other interaction by which the ad may be selected.

A content auction may be run to determine which content is to be output in response to an input, such as one or more keywords. In the auction, content providers may bid on specific keywords (which are associated with their content). For example, a sporting goods ads provider may associate words such as “baseball”, “football” and “basketball” with their ads. The content provider may bid on those keywords in the content auction, typically on a cost-per-click (CPC) basis. That is, the content provider's bid is an amount (e.g., a maximum amount) that the provider will pay in response to users clicking on their displayed content. So, for example, if a content provider bids five cents per click, then the content provider may pay five cents each time their content is clicked-on by a user, depending upon the type of the auction. In other examples, payment need not be on a CPC basis, but rather may be on the basis of other actions (e.g., an amount of time spent on a landing page, a purchase, and so forth).

Bidding in a content auction typically takes place against other content providers bidding for the same keywords. So, for example, if a user enters keywords into a search engine (to perform a search for related content), a content management system may select content items from different content providers, which are associated with those same keywords or variants thereof. The content auction is then run (e.g., by the content management system) to determine which content to serve along with the search results (or any other requested content). Typically, the winner of the content auction obtains the most preferred slots on a results page. The winner may be decided, e.g., based on bidding price, relevance of the keywords to content, and other factors. In this context, a page includes any display area, such as a Web page, a continuously scrollable screen, and so forth. In some examples, winners of the auction will be accorded the most preferred slot(s) on the page, while others will be accorded slots that are less preferred.

Using explicitly entered search keywords in auctions is an example of one of many approaches to implementing a content auction. For example, in some types of content network auctions, keywords are extracted from one or more pages surrounding content and used to identify, and implement, a content auction.

In some cases, rather than bidding on keywords, content providers may bid on other types of information. For example, a content provider may bid to distribute content to a particular geographic area, to a particular demographic, to particular types of content (e.g., Web pages), combinations of these, and so forth.

In some implementations, content providers may distribute content outside of an auction context, and use any of the types of information described herein (and others) to distribute content. For example, content providers may directly purchase space on Web pages that contain content about a particular subject or that are known to be frequented by a particular demographic. In other examples, content providers may pay to distribute their content to a particular geographic area. For example, the content may be distributed only to users known to live in, or frequent, a specific city, state, country, and so forth.

Content provider budgets are limited. Accordingly, it benefits content providers to have a way to allocate that budget in order to achieve an increase on their investment. Performance of past content distribution campaigns may be reviewed in order to determine how budget should be allocated. However, different campaign goals can lead to different conversion rates, making a review of the raw conversion data less informative as a predictor for future campaigns. For example, the objective of a first advertising campaign may be to have users sign-up to an email distribution list. In such a campaign, the conversion objective (e.g., a sign-up) is relatively easy to achieve, since it takes relatively little effort and does not require a product purchase. Accordingly, the conversion rate may be relatively high (e.g., one conversion per 100 clicks). By contrast, the objective of a second advertising campaign may be to have a user purchase a product. In such a campaign, the advertising objective (e.g., a sale) is more difficult to achieve, since it actually requires the user to purchase a product. Accordingly, the conversion rate may be relatively low (e.g., one conversion per 1000 clicks).

In both above examples of first and second advertising campaigns, the same distribution criteria may be used, e.g., the same keywords, the same geography, the same demographics, and so forth. However, because of the differences in conversion objectives, making a prediction based simply on information used for distribution and conversion rate may not be informative. Accordingly, the example systems described herein use relative conversion rates for various prior content distribution campaigns to make predictions about distribution methods to use in future campaigns. In some implementations, the systems identify distribution clusters that include a type of information used to distribute content and one or more instances of that type of information, determine relative conversion rates for the distribution clusters in different campaigns, compare the relative conversion rates, and use the comparison to make a budget allocation prediction.

By way of example, a system may identify a distribution cluster for advertising relating to cellular telephones. A distribution cluster may be, e.g., a type of information used to distribute content, such as keywords, geography, demographics, language, and so forth. The distribution cluster may include one or more instances or elements of information (e.g., distribution criteria) relating to the distribution cluster. For example, the distribution cluster may be for “keywords”, indicating that keywords are the method of distribution for the data relating to a certain cluster of keywords. For the “cell phone” example, the distribution criteria may be a number of keywords relating to cellular telephones, e.g., “4G LTE”, “texting”, “apps”, “smartphone”, and so forth.

The system may then determine, for different ad campaigns, what the relative conversion rate is for the above distribution cluster. The relative conversion rate may be determined for a set of (e.g., each) relevant ad campaigns for which historical performance data is known. Relevant ad campaigns may include, e.g., ad campaigns that are for cell phones and that use the distribution cluster for advertising. The relative conversion rate may be determined with respect to an average conversion rate for the distribution cluster for each considered ad campaign. So, in an example ad campaign for cell phones, the average conversion rate may be one conversion per 100 clicks. In another example ad campaign for cell phones, the average conversion rate may be one conversion per 1000 clicks. However, in both example ad campaigns, it may be determined that the relative conversion rate is two times (“2X”) the expected conversion rate, even though the absolute conversion rates for both campaigns are quite different (e.g., two conversions per 100 clicks versus two conversions per 1000 clicks).

The relative conversion rates of various distribution methods (e.g., keywords, Web-site, demographic, etc. distribution) may be compared to identify which distribution method(s) provides a desired increase(s) in conversion rate. The method(s) that provide the desired increase(s) may be suggested for use, and corresponding budget allocation, in future campaigns.

The distribution clusters may be defined according to any desired granularity, thereby possibly increasing or decreasing the accuracy of the predicted conversion rate for a distribution cluster.

In some implementations, the relative conversion rates may be correlated to the amount of money spent in budget to produce the corresponding relative conversion rates. That information may be used to generate a graphical (or other) representation from which information about the conversion rate of a campaign may be interpolated or extrapolated.

The example process described herein can be implemented in any appropriate network environment, with any appropriate devices and computing equipment. An example of such an environment is described below.

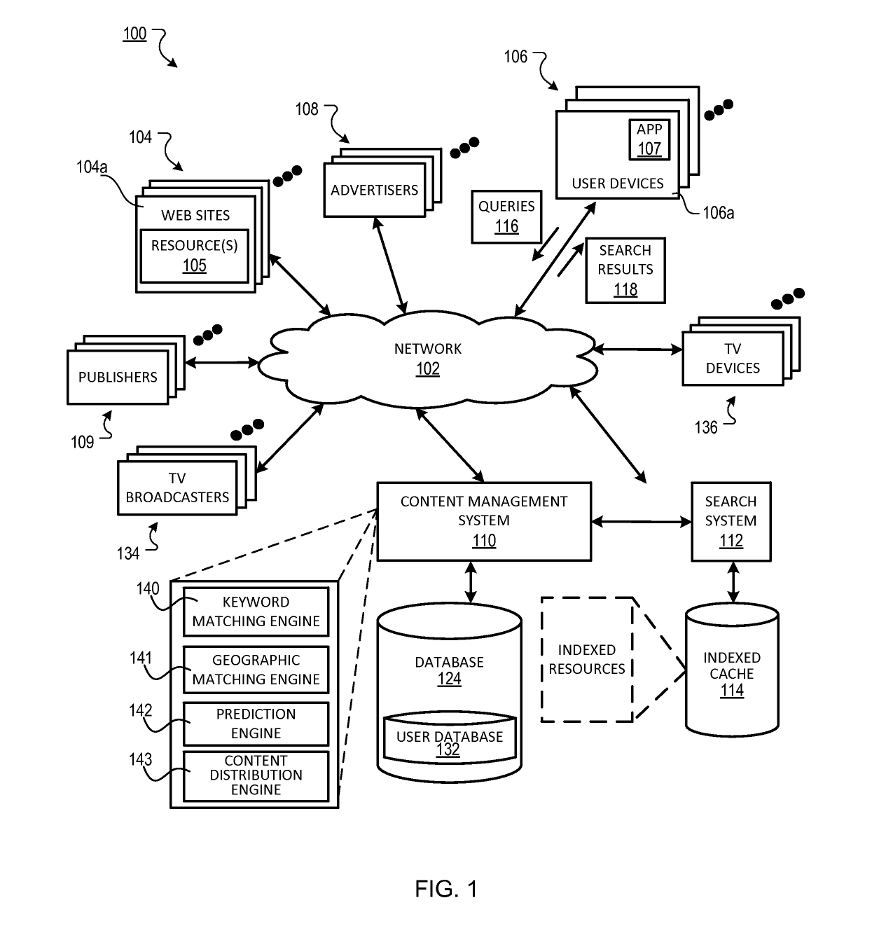

FIG. 1 is a block diagram of an example environment 100 for providing content to a user of a user device in accordance with the example processes described herein. The example environment 100 includes a network 102.

Network 102 can represent a communications network that can allow devices, such as a user device 106a, to communicate with entities on the network through a communication interface (not shown), which can include digital signal processing circuitry. Network 102 can include one or more networks. The network(s) can provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, General Packet Radio System (GPRS), or one or more television or cable networks, among others. For example, the communication can occur through a radio-frequency transceiver. In addition, short-range communication can occur, such as using a Bluetooth, WiFi, or other such transceiver.

Network 102 connects various entities, such as Web sites 104, user devices 106, content providers (e.g., advertisers 108), online publishers 109, and a content management system 110. In this regard, example environment 100 can include many thousands of Web sites 104, user devices 106, and content providers (e.g., advertisers 108). Entities connected to network 102 include and/or connect through one or more servers. Each such server can be one or more of various forms of servers, such as a Web server, an application server, a proxy server, a network server, or a server farm. Each server can include one or more processing devices, memory, and a storage system.

In FIG. 1, Web sites 104 can include one or more resources 105 associated with a domain name and hosted by one or more servers. An example Web site 104a is a collection of Web pages formatted in hypertext markup language (HTML) that can contain text, images, multimedia content, and programming elements, such as scripts. Each Web site 104 can be maintained by a publisher 109, which is an entity that controls, manages and/or owns the Web site 104.

A resource 105 can be any appropriate data that can be provided over network 102. A resource 105 can be identified by a resource address that is associated with the resource 105. Resources 105 can include HTML pages, word processing documents, portable document format (PDF) documents, images, video, and news feed sources, to name a few. Resources 105 can include content, such as words, phrases, images and sounds, that can include embedded information (such as meta-information hyperlinks) and/or embedded instructions (such as JavaScript scripts).

To facilitate searching of resources 105, environment 100 can include a search system 112 that identifies the resources 105 by crawling and indexing the resources 105 provided by the content publishers on the Web sites 104. Data about the resources 105 can be indexed based on the resource 105 to which the data corresponds. The indexed and, optionally, cached copies of the resources 105 can be stored in an indexed cache 114.

An example user device 106a is an electronic device that is under control of a user and that is capable of requesting and receiving resources over the network 102. A user device can include one or more processing devices, and can be, or include, a mobile telephone (e.g., a smartphone), a laptop computer, a handheld computer, an interactive or so-called “smart” television or set-top box, a tablet computer, a network appliance, a camera, an enhanced general packet radio service (EGPRS) mobile phone, a media player, a navigation device, an email device, a game console, or a combination of any two or more of these data processing devices or other data processing devices. In some implementations, the user device can be included as part of a motor vehicle (e.g., an automobile, an emergency vehicle (e.g., fire truck, ambulance), a bus).

User device 106a typically stores one or more user applications, such as a Web browser, to facilitate the sending and receiving of data over the network 102. A user device 106a that is mobile (or simply, “mobile device”), such as a smartphone or a table computer, can include an application (“app”) 107 that allows the user to conduct a network (e.g., Web) search. User devices 106 can also be equipped with software to communicate with a GPS system, thereby enabling the GPS system to locate the mobile device.

User device 106a can request resources 105 from a Web site 104a. In turn, data representing the resource 105 can be provided to the user device 106a for presentation by the user device 106a. User devices 106 can also submit search queries 116 to the search system 112 over the network 102. A request for a resource 105 or a search query 116 sent from a user device 106 can include an identifier, such as a cookie, identifying the user of the user device.

In response to a search query 116, the search system 112 can access the indexed cache 114 to identify resources 105 that are relevant to the search query 116. The search system 112 identifies the resources 105 in the form of search results 118 and returns the search results 118 to a user device 106 in search results pages. A search result 118 can include data generated by the search system 112 that identifies a resource 105 that is responsive to a particular search query 116, and includes a link to the resource 105. An example search result 118 can include a Web page title, a snippet of text or a portion of an image obtained from the Web page, and the URL (Unified Resource Location) of the Web page.

Content management system 110 can be used for selecting and providing content in response to requests for content. Content management system 110 also can, with appropriate user permission, update database 124 based on activity of a user. The user may enable and/or disable the storing of such information. In this regard, with appropriate user permission, the database 124 can store a profile for the user which includes, for example, information about past user activities, such as visits to a place or event, past requests for resources 105, past search queries 116, other requests for content, Web sites visited, or interactions with content. User interests may also be stored in the profile and, in some examples, may be determined from the information about past user activities. In some implementations, the information in database 124 can be derived, for example, from one or more of a query log, an advertisement log, or requests for content. The database 124 can include, for each entry, a cookie identifying the user, a timestamp, an IP (Internet Protocol) address associated with a requesting user device 106, a type of usage, and details associated with the usage.

Content management system 110 may include a keyword matching engine 140 to compare query keywords to content keywords and to generate a keyword matching score indicative of how well the query keywords match the content keywords. In an example, the keyword matching score is equal, or proportional, to a sum of a number of matches of words in the input query to words associated with the content. Content management system 110 may include a geographic (or “geo-”) matching engine 141 to compare geographic information (e.g., numerical values for place names) obtained from words in input queries to geographic information associated with content. Content management system 110 may also include other engines (not shown) for matching input demographics to desired demographics of an ad campaign, for identifying Web pages or other distribution mechanisms based on content, and so forth.

When a resource 105 or search results 118 are requested by a user device 106, content management system 110 can receive a request for content to be provided with the resource 105 or search results 118. The request for content can include characteristics of one or more “slots” that are defined for the requested resource 105 or search results page. For example, the data representing the resource 105 can include data specifying a portion of the resource 105 or a portion of a user display, such as a presentation location of a pop-up window or a slot of a third-party content site or Web page, in which content can be presented. An example slot is an ad slot. Search results pages can also include one or more slots in which other content items (e.g., ads) can be presented.

Information about slots can be provided to content management system 110. For example, a reference (e.g., URL) to the resource for which the slot is defined, a size of the slot, and/or media types that are available for presentation in the slot can be provided to the content management system 110. Similarly, keywords associated with a requested resource or a search query 116 for which search results are requested can also be provided to the content management system 110 to facilitate identification of content that is relevant to the resource or search query 116.

Based at least in part on data generated from and/or included in the request, content management system 110 can select content that is eligible to be provided in response to the request (“eligible content items”). For example, eligible content items can include eligible ads having characteristics matching keywords, geographic information, demographic information, known interests, etc. associated with corresponding content. In some implementations, the universe of eligible content items (e.g., ads) can be narrowed by taking into account other factors, such as previous search queries 116. For example, content items corresponding to historical search activities of the user including, e.g., search keywords used, particular content interacted with, sites visited by the user, etc. can also be used in the selection of eligible content items by the content management system 110.

Content management system 110 can select the eligible content items that are to be provided for presentation in slots of a resource 105 or search results page 118 based, at least in part, on results of an auction, such as a second price auction. For example, for eligible content items, content management system 110 can receive bids from content providers (e.g., advertisers 108) and allocate slots, based at least in part on the received bids (e.g., based on the highest bidders at the conclusion of the auction). The bids are amounts that the content providers are willing to pay for presentation (or selection) of their content with a resource 105 or search results page 118. For example, a bid for keywords can specify an amount that a content provider is willing to pay for each 1000 impressions (i.e., presentations) of the content item, referred to as a CPM bid. Alternatively, the bid for keywords can specify an amount that the content provider is willing to pay for a selection (i.e., a click-through) of the content item or a conversion following selection of the content item. This is referred to as cost-per-click (CPC). The selected content item can be determined based on the bids alone, or based on the bids of each bidder being multiplied by one or more factors, such as quality scores derived from content performance, landing page scores, and/or other factors.

In some implementations, a content provider can bid for an audience of users. For example, one or more of the publishers 109 and/or the content management system 110 can identify one or more audiences of users, where each user in the audience matches one or more criteria, such as matching one or more demographics, known interests, or other user-specific criteria.

An audience of users can be represented, for example, as a user list. User lists or other representations of audiences can be stored, for example, in a user database 132. A bid from a content provider can specify, for example, an amount that the content provider is willing to pay for each 1000 impressions (i.e., presentations) of the content item to a particular audience of users. The content management system 110 can, for example, manage the presentation of the content item to users included in a particular audience and can manage charging of the content provider for the impressions and distributing revenue to the publishers 109 based on the impressions.

In some implementations, TV (Television) broadcasters 134 produce and present television content on TV user devices 136, where the television content can be organized into one or more channels. The TV broadcasters 134 can include, along with the television content, one or more content slots in which other content (e.g., advertisements) can be presented. For example, a TV network can sell slots of advertising to advertisers in television programs that they broadcast. Some or all of the content slots can be described in terms of user audiences which represent typical users who watch content with which a respective content slot is associated. Content providers can bid, in an auction (as described above), on a content slot that is associated with keywords for particular television content.

Content management system 110 may include a prediction engine 142. Prediction engine 142 may implement all or part of the example processes described herein for determining resource allocation for content distribution. Content selected for output may be distributed by content distribution engine 143, which is also part of the content management system.

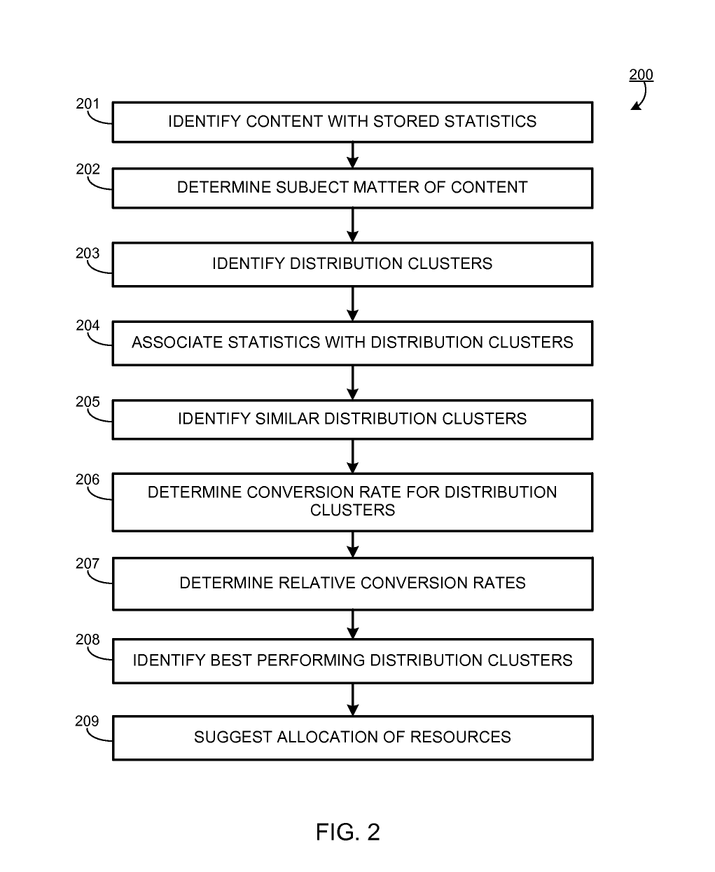

FIG. 2 is a flowchart showing an example process 200 that may be performed by content management system 110 including, at least partly, by prediction engine 142 for determining resource allocation for content distribution. Process 200 is described in the context of online advertising (“ads”); however, process 200 is applicable to determining resource allocation for any appropriate online content or other distributable content.

According to process 200, ads associated with stored statistics are identified (201). The stored statistics may include, but are not limited to, information such as the number of impressions made of each ad, the number of clicks on each ad, the number of conversions resulting from the clicks, the type of activity that constitutes a conversion, information used to distribute each ad, the campaign with which each ad is distributed, publications (e.g., Web sites) on which each ad was distributed during a campaign, and so forth. This information may be collected over time, and stored in a database 124. Users may have the option to prevent storage of personal or confidential information.

The subject of each ad is determined (202). The subject of each ad may be determined using any appropriate method. In some implementations, each ad may be stored with metadata. The metadata may identify the subject of each ad (e.g., cell phone, running shoes, computer, and so forth). In some implementations, the subject of each ad may be determined using image or pattern recognition of content in the ad. In some implementations, the subject of each ad may be identified using information provided by an advertiser and stored with the ad.

In some implementations, the subject matter of each ad may be categorized. For example, different words may be used to categorize the same subject. For example, an ad may be identified as for a “mobile phone” and another ad may be identified as for a “cellular telephone”. Although the two use different words to identify their subject matter, in normal speech, “mobile phone” and “cellular telephone” describe the same type of device. Accordingly, process 200 may identify the same type of device. A hierarchical categorization system may be used to identify different words or phrases that have the same meaning. In the above example, the hierarchical categorization system may have “mobile telephone” at its root and “mobile phone” and “cellular telephone” as branches off of that root. Accordingly, using such a hierarchical categorization system, the system would identify content identified as “cellular telephone” and a “mobile phone” as both being content for a “mobile telephone”.

Distribution clusters are identified (203) for subjects of the content (ads). In some implementations, a distribution cluster includes a type of information used to distribute content and one or more instances of that type of information. For example, the type of information may be keywords and the instances of that type of information may be specific keywords. In the example provided above, examples of keywords for use in an advertising campaign for mobile telephones may be “4G LTE”, “texting”, “apps”, and “smartphone”. Keywords relating to the same subject matter or concepts may be identified using a hierarchical categorization system of the type described above. In another example, the type of information may be demographics. In another example, the type of information may be geography, and the instances of that type of information may be US east coast and US west coast.

Appropriate stored statistics for each distribution cluster are associated (204) with each corresponding distribution cluster. As noted above, such stored statistics may include, but are not limited to, information such as the number of impressions made of each ad, the number of clicks on each ad, the number of conversions resulting from a number of clicks (conversion rate), the type of activity that constitutes a conversion, information used to distribute each ad, the campaign with which each ad is distributed, publications (e.g., Web sites) on which each ad was distributed during the campaign, and so forth. The association may be made using one or more constructs, such as pointers, look-up tables, or the like.

Similar distribution clusters, or “tuples”, are identified (205) in various campaigns. In some implementations, this operation includes identifying distribution clusters having the same information type(s) and the same instances of information (e.g., “keywords” as a type of information and the same keywords as instances of information). In other implementations, similar distribution clusters need not require all instances of information to be the same. For example, in some implementations, similar distribution clusters may include one or more, but not all, instances of information that are the same. In some implementations, distribution clusters may be defined by two types of information (e.g., “keywords” and “demographics”) and instances of each type of information (e.g., “4G LTE” and “smartphone” for “keywords”, and “US east coast” and “US west coast” for “demographics”). In such examples, similar distribution clusters may include distribution clusters having at least some common information (e.g., information types and/or instances of information).

The conversion rate for distribution clusters in each campaign are determined (206). For example, statistics about the distribution clusters are known from past campaigns. This information may be used to determine the conversion rate for each distribution cluster in each corresponding campaign.

The relative conversion rates of different distribution clusters in various campaigns are determined (207). This operation may be performed by generating a system of equations relating information about a campaign, the distribution type (e.g., keyword), and the observed conversion rate for the distribution type in the campaign. In some implementations, the system of equations may be as follows:

φᵢθₖ=cvrᵢₖ (1)

In equations (1), φᵢ is an aggregate conversion rate for a campaign “i”, θₖ is the distribution cluster relative conversion rate multiplier (hence, the subscript designation “k”), and cvrᵢₖ is the observed distribution cluster conversion rate “k” for campaign “i”. A distribution cluster having a neutral or average conversion rate would typically have a value of one for θₖ. In equations (1), only cvrᵢₖ is known from stored statistics relating for each campaign.

Equations (1) are solved for θₖ, which is the relative conversion rate for each distribution cluster k. For example, the relative conversion rate may indicate that a distribution cluster using keywords as a distribution method has a relative conversion rate of twice that of an average conversion rate in a campaign. In some implementations, equations (1) are solved using iterative proportional fitting. This solution mechanism includes initially setting all values of θₖ to one, estimating values for φᵢ that provide approximate solutions to the equations, and then alternating estimates of θₖ and φᵢ until a solution to equations (1) that has a desired level of stabilty is determined.

The values of θₖ, which are the relative conversion rates of different distribution clusters, are compared to identify (208) one or more distribution clusters that provide the best relative performance (e.g., the highest relative conversion rate(s)). This information is used to suggest (209) allocation of resources. For example, the information may be used to suggest that budget for advertising or other types of content distribution be skewed in favor of distribution clusters that provide the highest relative conversion rates. For example, if it is determined that keyword-based distribution produces the highest relative conversion rates, then it may be suggested that a majority of the advertising budget be allocated to keyword-based distribution. In some implementations, the allocation of advertising budget may be correlated to the relative conversion rates. For example, if the relative conversion rates of keyword distribution are two times higher than a baseline, and the relative conversion rates of Web site based distribution are about at the baseline, then it may be suggested that two times more advertising budget be allocated to keyword distribution than to Web site based distribution.

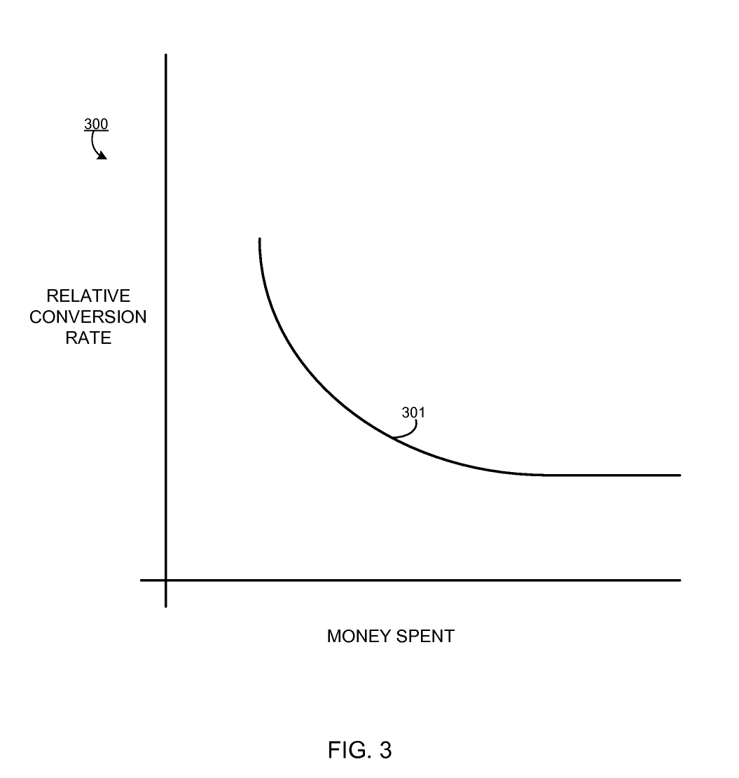

In some implementations, with the relative performance of distribution clusters known, and observed statistics about those distribution clusters also known, it is possible to generate a graph showing the amount of resources allocated, e.g., money spent, to achieve relative conversions. For example, referring to graph 300 of FIG. 3, the amount money spent is on the X-axis and the relative number of conversions is on the Y-axis. In this example, it is evident that there is a diminishing return 301 on investment. As is generally the case, after a point, spending additional money does not achieve a corresponding increase in total conversions. This information may also be helpful in determining how to allocate advertising or other content distribution budgets.

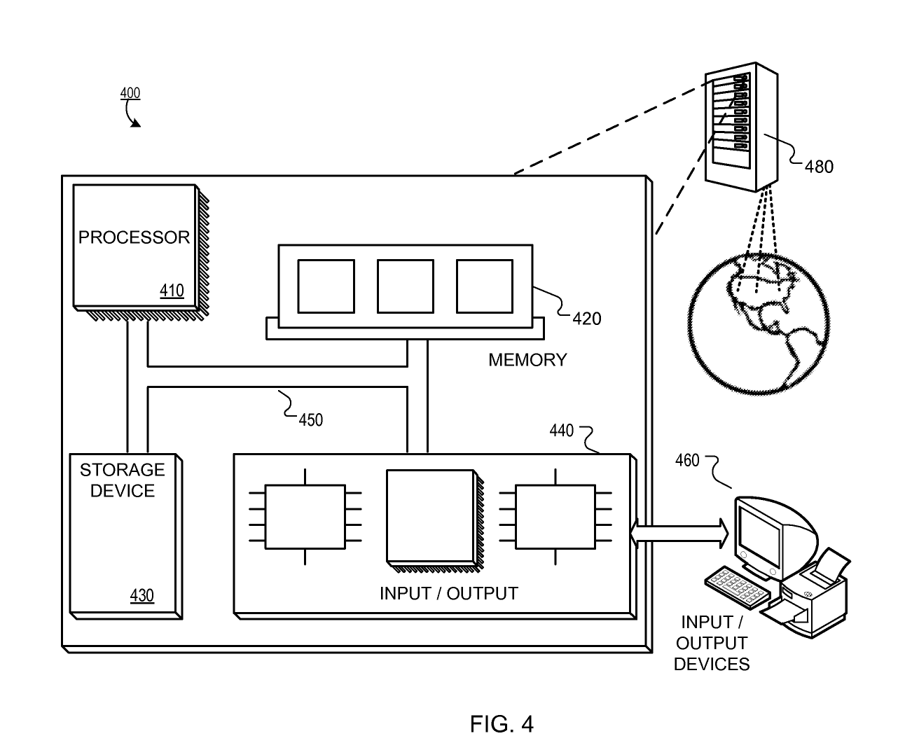

FIG. 4 is block diagram of an example computer system 400 that may be used in performing the processes described herein. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, or some other large capacity storage device.

The input/output device 440 provides input/output operations for the system 400. In one implementation, the input/output device 440 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 460.

The web server, advertisement server, and impression allocation module can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The web server and advertisement server can be distributively implemented over a network, such as a server farm, or can be implemented in a single computer device.

Example computer system 400 is depicted as a rack in a server 480 in this example. As shown the server may include multiple such racks. Various servers, which may act in concert to perform the processes described herein, may be at different geographic locations, as shown in the figure. The processes described herein may be implemented on such a server or on multiple such servers. As shown, the servers may be provided at a single location or located at various places throughout the globe. The servers may coordinate their operation in order to provide the capabilities to implement the processes.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

In this regard, various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Content, such as ads, generated according to the processes described herein may be displayed on a computer peripheral (e.g., a monitor) associated with a computer. The display physically transforms the computer peripheral. For example, if the computer peripheral is an LCD display, the orientations of liquid crystals are changed by the application of biasing voltages in a physical transformation that is visually apparent to the user. As another example, if the computer peripheral is a cathode ray tube (CRT), the state of a fluorescent screen is changed by the impact of electrons in a physical transformation that is also visually apparent. Moreover, the display of content on a computer peripheral is tied to a particular machine, namely, the computer peripheral.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

Elements of different implementations described herein can be combined to form other implementations not specifically set forth above. Elements can be left out of the processes, computer programs, Web pages, etc. described herein without adversely affecting their operation. In addition, the logic flows depicted in the figures do not require the particular order shown, or sequential order, to achieve desirable results. Various separate elements can be combined into one or more individual elements to perform the functions described herein.

Other implementations not specifically described herein are also within the scope of the following claims.

What is claimed is:

1. A method performed by one or more processing devices, comprising:
identifying campaigns for content distribution for which conversion information has been collected over time and stored in a database in computer storage, the identified campaigns having at least one subject in common;
for each of at least some of the campaigns, causing the one or more processing devices to perform operations comprising:
identifying distribution clusters associated with the campaign, a distribution cluster comprising a type of information used to distribute content and one or more instances of the type of information; and
determining relative conversion rates for the distribution clusters, a relative conversion rate indicating a performance of a distribution cluster relative to a baseline performance for the campaign, at least some of the distribution clusters using different types of information to distribute content; and
using relative conversion rates for distribution clusters, which have one or more features in common and are in different campaigns, in determining how to allocate resources for the content distribution.

2. The method of claim 1, wherein determining the relative conversion rates comprises:
establishing a set of equations, each equation relating a conversion rate for a campaign, a conversion rate for a distribution cluster in multiple campaigns, and an observed conversion rate for the distribution cluster in the campaign; and
solving the set of equations to determine a relative conversion rate for the distribution cluster.

3. The method of claim 2, wherein the set of equation is solved using iterative proportional fitting.

4. The method of claim 1, wherein determining how to allocate the resources comprises relating the relative conversion rates to resources to achieve the relative conversion rates.

5. The method of claim 4, wherein relating the relative conversion rates to resources to achieve the relative conversion rates comprises generating a graph of the relative conversion rates to the resources.

6. The method of claim 1, wherein the content comprises advertising and each relative conversion rate relates a conversion for corresponding advertising to a baseline performance for the advertising using the type of information and the one or more instances of the type of information.

7. The method of claim 1, wherein the type of information used to distribute content comprises a category of information and the instances comprise elements of the category.

8. The method of claim 7, wherein the category is keywords and the elements comprise individual keywords that are related.

9. The method of claim 8, further comprising:
identifying keywords among keywords used to distribute content; and
using a hierarchical structure to relate at least some of the identified keywords.

10. One or more machine-readable storage devices storing instructions that are executable by one or more processing devices to perform operations comprising:
identifying campaigns for content distribution for which conversion information has been collected over time and stored in a database in computer storage, the identified campaigns having at least one subject in common;
for each of at least some of the campaigns, performing the following operations:
identifying distribution clusters associated with the campaign, a distribution cluster comprising a type of information used to distribute content and one or more instances of the type of information; and
determining relative conversion rates for the distribution clusters, a relative conversion rate indicating a performance of a distribution cluster relative to a baseline performance for the campaign, at least some of the distribution clusters using different types of information to distribute content; and
using relative conversion rates for distribution clusters, which have one or more features in common and are in different campaigns, in determining how to allocate resources for the content distribution.

11. The one or more machine-readable storage devices of claim 10, wherein determining the relative conversion rates comprises:
establishing a set of equations, each equation relating a conversion rate for a campaign, a conversion rate for a distribution cluster in multiple campaigns, and an observed conversion rate for the distribution cluster in the campaign; and
solving the set of equations to determine a relative conversion rate for the distribution cluster.

12. The one or more machine-readable storage devices of claim 11, wherein the set of equation is solved using iterative proportional fitting.

13. The one or more machine-readable storage devices of claim 10, wherein determining how to allocate the resources comprises relating the relative conversion rates to resources to achieve the relative conversion rates.

14. The one or more machine-readable storage devices of claim 13, wherein relating the relative conversion rates to resources to achieve the relative conversion rates comprises generating a graph of the relative conversion rates to the resources.

15. The one or more machine-readable storage devices of claim 10, wherein the content comprises advertising and each relative conversion rate relates a conversion for corresponding advertising to a baseline performance for the advertising using the type of information and the one or more instances of the type of information.

16. The one or more machine-readable storage devices of claim 10, wherein the type of information used to distribute content comprises a category of information and the instances comprise elements of the category.

17. The one or more machine-readable storage devices of claim 17, wherein the category is keywords and the elements comprise individual keywords that are related.

18. The one or more machine-readable storage devices of claim 17, wherein the operations further comprise:
identifying keywords among keywords used to distribute content; and
using a hierarchical structure to relate at least some of the identified keywords.

19. A system comprising:
memory storing instructions that are executable; and
one or more processing devices to execute the instructions to perform operations comprising:
identifying campaigns for content distribution for which conversion information has been collected over time and stored in a database in computer storage, the identified campaigns having at least one subject in common;
for each of at least some of the campaigns, performing operations comprising:
identifying distribution clusters associated with the campaign, a distribution cluster comprising a type of information used to distribute content and one or more instances of the type of information; and
determining relative conversion rates for the distribution clusters, a relative conversion rate indicating a performance of a distribution cluster relative to a baseline performance for the campaign, at least some of the distribution clusters using different types of information to distribute content; and
using relative conversion rates for distribution clusters, which have one or more features in common and are in different campaigns, in determining how to allocate resources for the content distribution.

20. The method system claim 19, wherein determining the relative conversion rates comprises:
establishing a set of equations, each equation relating a conversion rate for campaign, a conversion rate for a distribution cluster in multiple campaigns, and an observed conversion rate for the distribution cluster in the campaign; and
solving the set of equations to determine a relative conversion rate for the distribution cluster.
